(19) United States
(12) Patent Application Publication
(10) Pub. No.: US 2012/0206482 A1
(43) Pub. Date: Aug. 16, 2012

(54) METHOD FOR IDENTIFYING INFECTED ELECTRONIC FILES

(76) Inventor: Vitaly Evgenievich Pilkin, Moscow (RU)

(21) Appl. No.: 13/502,587

(22) PCT Filed: Sep. 22, 2010
(86) PCT No.: PCT/RU10/00524

§ 371 Date: Apr. 18, 2012

(30) Foreign Application Priority Data
Nov. 16, 2009 (RU) 2009142185

(51) Int. Cl. G09G 5/00

(52) U.S. Cl. 345/619

(57) ABSTRACT

The invention relates to electronic engineering and in particular to a method for identifying infected electronic files on a display (monitor) of an electronic device, said infected electronic files being located in the electronic device or on the Internet. The aim of the proposed invention is to provide a novel method of identifying infected electronic files. As a result of the use of the proposed invention, the user of the electronic device or the Internet is provided with the possibility of discovering infected electronic files with the aid of different identification methods which distinguish infected electronic files from uninfected electronic files.

### CROSS-REFERENCE TO RELATED APPLICATIONS

This application is a U.S. national stage application of a PCT application PCT/RU2010/000524 filed on 22 Sep. 2010, published as WO/2011/059363, whose disclosure is incorporated herein in its entirety by reference, which PCT application claims priority of a Russian Federation application RU2009142185 filed on 16 Nov. 2009.

### FIELD OF THE INVENTION

The present invention relates to electronic engineering and in particular to the method for identifying infected electronic files located in the electronic device or on the Internet and displayed on a visual display (monitor) of an electronic device in form of a virtual symbol or a virtual object or a virtual icon denoting an infected electronic file.

### BACKGROUND OF THE INVENTION

It's known the method of detecting infected files via antivirus software, for example, Kaspersky antivirus software, which is capable to detect infected electronic files by scanning electronic files. For more details http://www.kaspersky.com/. The disadvantage of the above-mentioned antivirus software is that a user of an electronic device or a user of the Internet has no possibility to identify immediately an infected file and has to spend a certain time to identify it with antivirus software.

The closest in technical essence (the prototype) is a textual designation of an infected electronic file. In some Internet search systems, e.g. Google (for more details see www.google.com), some active Internet links to Internet sites are accompanied with a textual message, warning the user of potential risk for his/her electronic device in case the user opens the Internet site. The disadvantage of the said technical solution is that it doesn't provide variability in identifying infected electronic files.

### OBJECTIVES AND DESCRIPTION OF THE INVENTION

Technical solution of the given invention is aimed at developing a new method for identifying infected electronic files located in an electronic device or on the Internet.

The given invention allows the user of an electronic device or the Internet to identify infected electronic files by means of using different methods of designation of virtual symbols or objects or icons, which denote infected electronic files. The technical result is to provide variability in identifying infected electronic files. For correct understanding and interpretation of terms described herein, the following terminology has been used:

Electronic device means a personal computer (PC), notebook, netbook, pocket PC (PDA), smartphone, digital phone, digital camera, digital camcorder, digital multimedia device and other known electronic devices, which can receive electronic files from other electronic devices or from the Internet.

Electronic file means an electronic file, containing textual and/or graphics and/or video and/or audio and/or other information in electronic format known from the technical art.

Infected electronic file means an electronic file, subjected to impact of harmful activities of malicious electronic programs or program elements and/or objects, e.g. viruses, spy programs, Trojan software, worms and other malicious software and its elements, which worsen the operation and/or perform harmful activities and/or threaten the safety of the electronic file and other electronic files and programs located in an electronic device.

Virtual symbol or virtual object denoting an infected electronic file means an active link (for example, Internet link) to an infected electronic file. The above mentioned technical result is achieved as follows:

displayed on a visual display of an electronic device a virtual symbol or a virtual object or a virtual icon denoting an infected electronic file has a completely or partially another color and/or brightness and/or size and/or shape which distinguishes it from a virtual symbol or a virtual object or a virtual icon denoting an uninfected electronic file, or

displayed on a visual display of an electronic device a virtual symbol or a virtual object or a virtual icon denoting an infected electronic file blinks, or

a cursor pointed on a virtual symbol or a virtual object or a virtual icon denoting an infected electronic file blinks and/or changes a color of the cursor and/or a brightness of the cursor and/or a size of the cursor and/or a shape of the cursor, or

displayed on a visual display of an electronic device a virtual symbol or a virtual object or a virtual icon denoting an infected electronic file is overlaid with another virtual symbol or virtual object or virtual icon, or

displayed on a visual display of an electronic device a virtual symbol or a virtual object or a virtual icon denoting an infected electronic file gives out a sound when a cursor is pointed on it or, if a visual display is a touch screen display, when the user's finger or a stylus touches it, or

a textual message warning that the electronic file is infected is displayed near and/or over a displayed on a visual display of an electronic device virtual symbol or virtual object or virtual icon denoting an infected electronic file, or

a textual message warning that the electronic file is infected appears when the cursor is pointed on the displayed on a visual display of an electronic device a virtual symbol or a virtual object or a virtual icon denoting an infected electronic file or, if a visual display is a touch screen display, when the user's finger or a stylus touches it.

Through various services (settings) of an electronic device a user himself can set a convenient method for identifying infected electronic files.

### EMBODIMENT OF THE INVENTION

The given invention is considered feasible, since it can be implemented in practice through application of the electronic devices technical means and software known in the technical art.

### Application of the Invention

Due to application of the given invention the users of electronic devices will be able to identify infected electronic files located in electronic devices and on the Internet much easier and faster.

1. A method for identifying infected electronic files, wherein:
displayed on a visual display of an electronic device a virtual symbol or a virtual object or a virtual icon denoting an infected electronic file has a completely or partially another color and/or brightness and/or size and/or shape which distinguishes it from a virtual symbol or a virtual object or a virtual icon denoting an uninfected electronic file,
or
displayed on a visual display of an electronic device a virtual symbol or a virtual object or a virtual icon denoting an infected electronic file blinks,
or
a cursor pointed on a virtual symbol or a virtual object or a virtual icon denoting an infected electronic file blinks and/or changes a color of the cursor and/or a brightness of the cursor and/or a size of the cursor and/or a shape of the cursor,
or
displayed on a visual display of an electronic device a virtual symbol or a virtual object or a virtual icon denoting an infected electronic file is overlaid with another virtual symbol or virtual object or virtual icon,
or
displayed on a visual display of an electronic device a virtual symbol or a virtual object or a virtual icon denoting an infected electronic file gives out a sound when a cursor is pointed on it or, if a visual display is a touch screen display, when the user's finger or a stylus touches it,
or
a textual message warning that the electronic file is infected is displayed near and/or over a displayed on a visual display of an electronic device virtual symbol or virtual object or virtual icon denoting an infected electronic file,
or
a textual message warning that the electronic file is infected appears when the cursor is pointed on the displayed on a visual display of an electronic device a virtual symbol or a virtual object or a virtual icon denoting an infected electronic file or, if a visual display is a touch screen display, when the user's finger or a stylus touches it.

2. The method according to claim 1, wherein through various services (settings) of an electronic device a user himself sets a convenient method for identifying infected electronic files.
